(19) United States
(12) Patent Application Publication
(10) Pub. No.: US 2002/0052446 A1
(43) Pub. Date: May 2, 2002

(54) Composition based on monofluorometal complexes

(76) Inventors: Sigurd Becke, Rosrath (DE); Uwe Rosenthal, Rostock-Sievershagen (DE); Wolfgang Baumann, Rostock (DE); Perdita Arndt, Kritzmow (DE); Anke Spannenberg, Rostock (DE)

Correspondence Address: Patent Department, Bayer Corporation, 100 Bayer Road, Pittsburgh, PA, 15205-9741, US

(21) Appl. No.: 10/001,131

(22) Filed: Oct. 23, 2001

(30) Foreign Application Priority Data
Oct. 27, 2000 (DE) 10053486.4

(51) Int. Cl. C08F 8/00; B01J 31/00

(52) U.S. Cl. 525/192; 502/102; 502/103; 525/117; 502/153; 502/152; 502/154; 502/155

(57) ABSTRACT

The present invention relates to a composition based on monofluorometal complexes, a process for the production of monofluorometal complexes, in particular a catalyst system comprising metallocene monofluorides and aluminum alkyls, as well as the use of the catalyst system for the polymerization of unsaturated compounds, in particular for the polymerization and copolymerization of olefins and/or dienes.

### FIELD OF THE INVENTION

The present invention relates to a composition based on monofluorometal complexes, a process for the production of monofluorometal complexes, in particular, a catalyst system comprising metallocene monofluorides and aluminum alkyls, as well as the use of the catalyst system for the polymerization of unsaturated compounds, in particular for the polymerization and copolymerization of olefins and/or dienes.

### BACKGROUND OF THE INVENTION

Highly active, specific catalyst systems for the (co)polymerization of ethylene and/or 1-olefins, comprising metallocene dichlorides mixed with aluminoxanes, for example methyl aluminoxane (MAO), are known. In order to improve the activity, selectivity, control of the microstructure, molecular weights and molecular weight distribution, a large number of new metallocene catalysts and metallocene catalyst systems have been developed in recent years for the polymerization of olefinic compounds (e.g. EP-A1-69 951, -A2-129 368, -A1-347 128, -A1-347 129, -A2-351 392, -A1-485 821, -A1-485 823). Normally, chlorine-containing metallocenes are used in combination with MAO.

In WO-97/07141-A1, monocyclopentadienyl-fluoro complexes of titanium are used in combination with MAO as catalysts for the production of polystyrene. Compared to monocyclopentadienyl-chloro complexes, higher catalyst activities are achieved with the corresponding fluoro complexes. WO-98/36004-A1 describes fluorine-containing complexes, preferably of titanium and preferably in combination with MAO, as catalysts for the production of polybutadiene.

The aforedescribed catalyst systems based on aluminoxanes, e.g. MAO, have, however, disadvantages, which are discussed in more detail hereinafter. MAO is a mixture of different aluminum compounds whose number and structure are not precisely known. Accordingly the polymerization of olefins with catalyst systems containing MAO is not always reproducible. Furthermore, MAO is not stable on storage and changes its composition under thermal stress. MAO has the further disadvantage that it has to be used in large excess in order to achieve high catalyst activities. This leads to a large proportion of aluminum in the polymer. Furthermore, MAO is a cost-decisive factor. MAO employed in large excess is also uneconomical for industrial use.

In order to obviate these disadvantages, aluminoxane-free polymerization catalysts have been developed in recent years. For example, Jordan, et al. in J. Am. Chem. Soc., Vol. 108 (1986), 7410, describes a cationic zirconocene-methyl complex that contains tetraphenyl borate as counter ion-and polymerizes ethylene in methylene chloride. EP-A1-277 003 and EP-A1-277 004 describe ionic metallocenes that are produced by reacting metallocenes with ionizing reagents. EP-A 468 537 describes catalysts having an ionic structure that are formed by reacting metallocene dialkyl compounds with tetrakis(pentafluorophenyl)boron compounds. The ionic metallocenes are suitable as catalysts for the polymerization of olefins. A disadvantage, however, is the high sensitivity of the catalysts to impurities such as, for example, moisture and oxygen.

The processes corresponding to the prior art for forming cationic metallocene complexes also have the disadvantage that the cationizing reagents, e.g. tetrakis(pentafluorophenyl)boron compounds, are in some cases, difficult to synthesize and their use is cost-intensive.

The earlier application DE 199 32 409 describes a catalyst system based on fluorine-containing metal complexes, in particular a catalyst system consisting of metallocene fluorides in general and aluminum alkyls. The special metallocene monofluoride systems disclosed in this application are not disclosed in the earlier application.

The production and characterization of bis(cyclopentadienyl) metal difluorides of titanium, zirconium and hafnium is described in J. Chem. Soc. (A), 1969, 2106-2110.

A process for the production of π-system-containing organometallic fluorides is described in DE-A1-43 32 009. In this process tin fluorides are used as fluorinating agent, the corresponding metallocene difluorides being prepared, for example, starting from metallocene dichlorides by halogen exchange.

In J. Chem. Soc. Chem. Commun. 1986, page 1610-1611 titanocene difluoride and titanocene monofluoride are obtained as decomposition products of the unstable cationic complex [bis(cyclopentadienyl)methyltitanium]-tetrafluoroborate. The formation of zirconocene difluoride as a decomposition product of the complex [bis(cyclopentadienyl)(acetonitrile)methylzirconium]-hexafluorophosphate is reported in J. Am. Chem. Soc. 1986, 108, page 1718-1719. The monofluoro complex [bis(cyclopentadienyl)methylzirconium] fluoride is presumed to be an intermediate product.

The monofluoro complex [bis(cyclopentadienyl)methylzirconium] fluoride is also formed by a ligand exchange reaction of zirconocene dimethyl and zirconocene difluoride, as reported in J. Organometallic Chemistry, 294 (1985) pp. 321-326.

The production of rac-ethylenebis(4,5,6,7-tetrahydroindenyl)zirconium fluoride by reacting the monoazadiene complex ethylenebis(4,5,6,7-tetrahydroindenyl)-zirconium(2-vinylpyridine) with tetrafluoroboric acid is described in Organometallics 1998, 17, 2096-2102. The monofluoro complex rac-(EBTHI)-Zr(F){2-(2-pyridyl)ethyl} postulated as intermediate product could however not be identified or isolated.

Nothing is known concerning the catalytic activity of the aforedescribed monofluorometal complexes.

### SUMMARY OF THE INVENTION

Accordingly, the object of the present invention was to provide an aluminoxane-free composition that at least to some extent avoids the disadvantages of the prior art and whose use as catalyst, nevertheless, permits high polymerization activities. A further object of the present invention is to provide an aluminoxane-free catalyst system for the production of polyolefin rubbers, in particular for EP(D)M.

It has now surprisingly been found that catalyst systems based on monofluorometal complexes are particularly suitable for the aforementioned objects.

### DETAILED DESCRIPTION OF THE INVENTION

The present invention accordingly provides a composition comprising substantially

a) a monofluorometal complex of the formula (I)

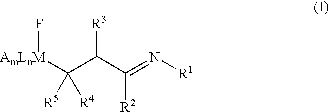

wherein

M is a transition metal from Groups III, IV, V or VI or from the group of lanthanoids or actinides of the Periodic System of the Elements according to IUPAC 1985,

R¹, R², R³, R⁴, R⁵ are identical or different and denote hydrogen, a C₁-C₂₀ alkyl group, a C₁-C₁₀ fluoroalkyl group, a C₆-C₁₀ fluoroaryl group, a C₁-C₁₀ alkoxy group, a C₆-C₂₀ aryl group, a C₆-C₁₀ aryloxy group, a C₂-C₁₀ alkenyl group, a C₇-C₄₀ arylalkyl group, a C₇-C₄₀ alkylaryl group, a C₈-C₄₀ arylalkenyl group, a C₂-C₁₀ alkinyl group, or a silyl group optionally substituted by C₁-C₁₀ hydrocarbon radicals, or

R¹, R², R³, R⁴, R⁵ in each case together with the atoms bonding them form one or more aliphatic or aromatic ring systems that may contain one or more heteroatoms (O, N, S) and that have 5 to 10 carbon atoms

A denotes an optionally singly or multiply bridged anionic ligand,

F denotes a fluorine atom,

L is a non-ionic ligand,

m is 1, 2, 3,

n is 0, 1, 2, 3, 4, preferably 1, 2or 3, and

b) is a compound of the formula (II)

M′ Y₃ (II)

wherein

M′ denotes boron or aluminum and

Y is identical or different and denotes hydrogen, a linear or branched C₁-C₂₀ alkyl group optionally substituted by silyl groups, a linear or branched C₁-C₁₀ fluoroalkyl group, a C₆-C₁₀ fluoroaryl group, a C₁-C₁₀ alkoxy group, a C₆-C₂₀ aryl group, a C₆-C₂₀ aryloxy group, a C₇-C₄₀ arylalkyl group, or a C₇-C₄₀ alkylaryl group.

Particularly suitable monofluorometal complexes of the formula (I) are those in which

A is identical or different and denotes

a pyrazolyl borate of the formula R⁶B(N₂C₃R⁷₃)₃,

an alcoholate or phenolate of the formula OR⁶,

a thiolate of the formula SR⁶,

an amide of the formula NR⁶₂,

a siloxane of the formula OSiR⁶₃,

an acetyl acetonate of the formula (R⁶CO)₂CR⁶,

an amidinate of the formula R⁶C(NR⁶)₂,

a cyclooctatetraenyl of the formula C₈H_{q}R⁶_{8-q} where q denotes 0, 1, 2, 3, 4, 5, 6, 7

a cyclopentadienyl of the formula C₅H_{q}R⁶_{5-q} where q denotes 0, 1, 2, 3, 4, 5,

an indenyl of the formula C₉H₇₋ᵣR⁶r where r denotes 0, 1, 2, 3, 4, 5, 6, 7

a fluorenyl of the formula C₁₃H₉₋ₛR⁶ₛ where s denotes 0, 1, 2, 3, 4, 5, 6, 7, 8, 9

a C₁-C₂₀ alkyl radical, a C₆-C₁₀ aryl radical, as well as a C₇-C₄₀ alkylaryl radical,

wherein

R⁶ is identical or different and denotes hydrogen, a C₁-C₂₀ alkyl group, a C₁-C₁₀ fluoralkyl group, a C₆-C₁₀ fluoroaryl group, a C₁-C₁₀ alkoxy group, a C₆-C₂₀ aryl group, a C₆-C₁₀ aryloxy group, a C₂-C₁₀ alkenyl group, a C7-C40 arylalkyl group, a C₇-C₄₀ alkylaryl group, a C₈-C₄₀ arylalkenyl group, a C₂-C₁₀ alkinyl group, a silyl group optionally substituted by C₁-C₁₀ hydrocarbon radicals, a boryl group, an amino group, a phosphinyl group, or adjacent radicals R¹ together with the atoms bonding them form a ring system,

R⁷ denotes hydrogen or a C₁-C₁₀ alkyl group and

M, F, L, R¹, R², R³, R⁴, R⁵ and m, n have the aforementioned meanings.

Suitable non-ionic ligands L are for example ethers, thioethers, cyclic ethers, cyclic thioethers, amines or phosphines.

As monofluorometal complexes of the formula (i), particularly preferred are those complexes that contain an optionally substituted cyclopentadienyl ring as ligand A and M denotes titanium, zirconium, hafnium, vanadium, niobium and tantalum. Catalyst systems with these catalyst components have a good polymerization activity.

M is preferably titanium or zirconium, and more preferably, zirconium.

According to the present invention, a catalyst component is provided containing at least one bridging R⁸ between at least two ligands A.

R⁸ is preferably

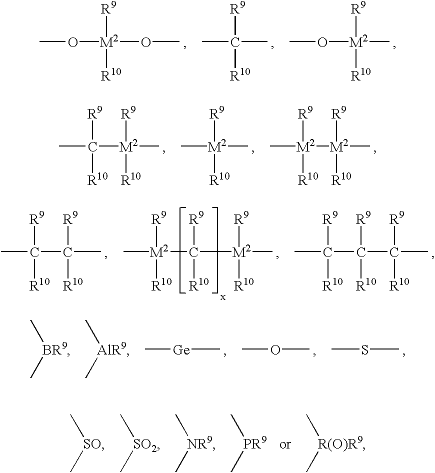

wherein R⁹ and R¹⁰ are identical or different and denote a hydrogen atom, a halogen atom or a C₁-C₄₀ carbon-containing group such as a C₁-C₂₀ alkyl, a C₁-C₁₀ fluoroalkyl, a C₁-C₁₀ alkoxy, a C₆-C₁₄ aryl, a C₆-C₁₀ fluoroaryl, a C₆-C₁₀ aryloxy, a C₂-C₁₀ alkenyl, a C₇-C₄₀ arylalkyl, a C₇-C₄₀ alkylaryl, or a C₈-C₄₀ arylalkenyl group, or R⁹ and R¹⁰ together with the atoms bonding them in each case form one or more rings, and x is an integer from 0 to 18, and M² is silicon, germanium or tin; R³ may also couple together two units of the formula (I).

The following examples are intended to illustrate in more detail the preferred anionic ligands A covered by the general formula (I), but make no claim to completeness:

Ethylenebis(indenyl)

Ethylenebis(4,5,6,7-tetrahydroindenyl)

Ethylenebis(2-methylindenyl)

Ethylenebis(2,4-dimethylindenyl)

Dimethylsilandiylbis(2-methyl-4,5-benzoindenyl)

Dimethylsilandiylbis(2-methyl-4,6-diisopropylindenyl)

Dimethylsilandiylbis(2-methyl-4-phenylindenyl)

Dimethylsilandiylbis(2-ethyl-4-phenylindenyl)

Dimethylsilandiylbis(2-methyl-4-(1-naphthyl)indenyl)

Dimethylsilandiylbis(indenyl)

Dimethylsilandiylbis(2-methyl-4-ethylindenyl)

Dimethylsilandiylbis(2-methyl-4-isopropylindenyl)

Dimethylsilandiylbis(2-methyl-4-methylindenyl)

Dimethylsilandiylbis(2-ethyl-4-methylindenyl)

Dimethylsilandiylbis(2-methyl-α-acenaphth-1-indenyl)

Phenylmethylsilandiylbis(2-methyl -4-phenylindenyl)

Phenylmethylsilandiylbis(2-methylindenyl)

Ethylenebis(2-methyl-4,5-benzoindenyl)

Ethylenebis(2-methyl-4,6-diisopropylindenyl)

Ethylenebis(2-methyl-4-phenylindenyl)

Ethylenebis(2-ethyl-4-phenylindenyl )

Ethylenebis(2-methyl-4-(1-naphthyl)indenyl)

Ethylenebis(indenyl)

Ethylenebis(2-methyl-4-ethylindenyl)

Ethylenebis(2-methyl-4-isopropylindenyl)

Ethylenebis(2-methyl-4-methylindenyl)

Ethylenebis(2-ethyl-4-methylindenyl)

Ethylenebis(2-methyl-α-acenaphth-1-indenyl)

(2-methyl-4, 5-benzoindenyl)

(2-methyl-4,6-diisopropylindenyl)

(2-methyl-4-phenylindenyl)

(2-ethyl-4-phenylindenyl)

(2-methyl-4-(1-naphthyl)indenyl)

(indenyl)

(2-methyl-4-ethylindenyl)

(2-methyl-4-isopropylindenyl)

(2-methyl-4-methylindenyl)

(2-ethyl-4-methylindenyl)

(2-methyl-α-acenaphth-1-indenyl)

(n-butyl-cyclopentadienyl)

(cyclopentadienyl)

Pentamethylcyclopentadienyl

Fluorenyl

Diphenylmethylene(9-fluorenyl)cyclopentadienyl

Phenylmethylmethylene(9-fluorenyl)cyclopentadienyl

Dimethylsilandiyl(9-fluorenyl)cyclopentadienyl

Isopropylidene(9-fluorenyl)(3-methyl-cyclopentadienyl)

Diphenylmethylene(9-fluorenyl)(3-methyl-cyclopentadienyl)

Phenylmethylmethylene(9-fluorenyl)(3-methyl-cyclopentadienyl)

Dimethylsilandiyl(9-fluorenyl)(3-methyl-cyclopentadienyl)

Isopropylidene(9-fluorenyl)(3-isopropyl-cyclopentadienyl)

Diphenylmethylene(9-fluorenyl)(3-isopropyl-cyclopentadienyl)

Phenylmethylmethylene(9-fluorenyl)(3-isopropyl-cyclopentadienyl)

Dimethylsilandiyl(9-fluorenyl)(3-isopropyl-cyclopentadienyl)

Isopropylidene(2,7-ditert.-butyl-9-fluorenyl)cyclopentadienyl

Diphenylmethylene(2,7-ditert.-butyl-9-fluorenyl)cyclopentadienyl

Phenylmethylmethylene(2,7-ditert.-butyl-9-fluorenyl)

Dimethylsilandiyl(2,7-ditert.-butyl-9-fluorenyl)cyclopentadienyl

Most preferred are monofluorometal complexes of the formula (Ia)

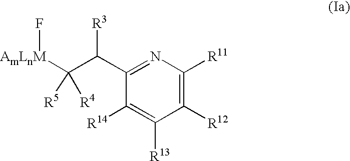

wherein

R¹¹, R¹², R¹³ and R¹⁴ are identical or different and denote hydrogen or a C₁-C₁₀ alkyl group and

M, F, A, L, R³, R⁴, R⁵ and m, n have the meanings mentioned hereinbefore.

Particularly suitable as compounds of the formula (II) are triethylaluminum, diethylaluminum hydride, triisobutylaluminum, disobutylaluminum hydride, triisohexylaluminum, tris-(2,3,3-trimethylbutyl)aluminum, tris-(2,3-dimethyl-hexyl)aluminum, tris-(2,3-dimethylbutyl)aluminum, tris-(2,3-dimethylpentyl)-aluminum, tris-(2,3-dimethylheptyl)aluminum, tris-(2-methyl-3-ethylpentyl)-aluminum, tris-(2-methyl-3-ethylhexyl)aluminum, tris-(2-methyl-3-ethylheptyl)-aluminum, tris-(2-methyl-3-propylhexyl) aluminum, tris-(2-ethyl-3-methyl butyl)-aluminum, tris-(2-ethyl-3-methylpentyl)aluminum, tris-(2,3-diethylpentyl)-aluminum, tris-(2-propyl-3-methylbutyl)aluminum, tris-(2-isopropyl-3-methylbutyl)aluminum, tris-(2-isobutyl-3-methylpentyl)aluminum, tris-(2,3,3-trimethylpentyl)aluminum, tris-(2,3,3-trimethylhexyl)aluminum, tris-(2-ethyl-3,3-dimethylbutyl)aluminum, tris-(2-ethyl-3,3-dimethylpentyl)aluminum, tris-(2-isopropyl-3,3-dimethylbutyl)aluminum, tris-(2-trimethylsilylpropyl)aluminum, tris-(2-methyl-3-phenyl-butyl)aluminum, tris-(2-ethyl-3-phenylbutyl)aluminum, tris-(2,3-dimethyl-3-phenylbutyl)aluminum, tri-(2-phenylpropyl)aluminum, tri-benzylaluminum, triphenylaluminum, tri(neopentyl)aluminum, tri(trimethylsilyl-methyl)aluminum. More preferred are triisobutylaluminum, tri-(2-phenylpropyl)aluminum and tri-(2,4,4-trimethylpentyl)aluminum. Also suitable as compounds of the formula (II) are perfluorinated triaryl compounds of aluminum or boron, such as tris(pentafluorophenyl)aluminum and tris(pentafluorophenyl)boron. The compounds of the formula (II) may also be present as mixtures.

The trialkylaluminum compounds and dialkylaluminum hydrides may be prepared according to the method described in Liebigs Annalen der Chemie, Vol. 629, pp. 14-19.

The present invention also provides a process for the production of monofluorometal complexes of the formula (I), characterized in that a monoazadiene complex of the formula (III)

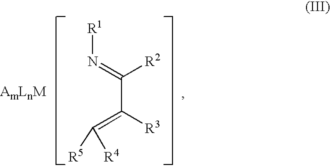

wherein

M, L, R¹, R², R³, R⁴, R⁵ and m, n have the meanings mentioned hereinbefore, is reacted with anhydrous hydrogen fluoride or with an addition complex containing hydrogen fluoride in bound form.

Suitable addition complexes are, for example, adducts of hydrogen fluoride with nitrogen-containing Lewis bases. Suitable nitrogen-containing Lewis bases are, for example, ammonia or aliphatic or aromatic amines. Examples of aliphatic amines are trialkylamines such as trimethylamine, triethylamine, tripropylamine, tributylamine and trioctylamine. Examples of aromatic amines are aniline, dimethylaniline, toluidine, diphenylamine and triphenylamine. Also suitable are adducts of hydrogen fluoride with nitrogen-containing heterocyclic compounds such as pyrrole, pyridine and picoline. Also suitable are addition complexes of hydrogen fluoride with ammonium fluoride, alkyl ammonium fluorides or aryl ammonium fluorides. Preferred addition complexes are ammonium fluoride, ammonium hydrogen difluoride, anilinium fluoride, triethylamine trihydrofluoride, tetrabutylammonium hydrogen difluoride and the adduct of hydrogen fluoride-and pyridine.

The preparation of the monofluorometal complexes of the formula (I) generally takes place in a suitable reaction medium at temperatures of −100° to +120° C., preferably −78° to +100° C., more preferably −40° to +80° C. Suitable reaction media are, for example, aromatic hydrocarbons, halogenated hydrocarbons, ethers and cyclic ethers. Examples of suitable media are benzene, toluene, zylene and ethers such as dialkyl ether, dimethoxyethane and tetrahydrofuran. Mixtures of various solvents are also suitable. The preferred molar ratio of monoazadiene complexes of the formula (III) to hydrogen fluoride is 1:1.

The preparation of the monoazadiene complexes of the formula (III) is described, for example, in U.S. Pat. No. 5,965,678.

The monofluorometal complexes of the formula (I) that can be produced by the process according to the present invention may be isolated or used directly for further reactions. If an isolation is necessary, the byproducts that are formed may be removed by the conventional purification methods, e.g. by filtration. Alternatively, the desired products may also be extracted with a solvent. If necessary, a purification operation, for example recrystallization, may be performed.

The present invention also provides for the use of the composition according to the present invention as a catalyst system for the polymerization of unsaturated compounds, in particular olefins and dienes. The term polymerization is understood to include homopolymerization as well as copolymerization of the aforementioned unsaturated compounds. In particular, C₂-C₁₀ alkenes such as ethylene, propylene, butene-1, pentene-1 and hexene-1, octene-1, isobutylene and arylalkenes such as styrene are used in the polymerization. The following are used, in particular, as dienes: conjugated dienes such as 1,3-butadiene, isoprene, 1,3-pentadiene, and unconjugated dienes such as 1,4-hexadiene, 1,5-heptadiene, 5,7-dimethyl-1,6-octadiene, 7-methyl-1,6-octadiene, 4-vinyl-1-cyclohexene, 5ethylidene-2-nobornene, 5-vinyl-2-norbornene and dicyclopentadiene.

The catalysts according to the present invention are suitable for the production of rubbers based on copolymers of ethylene with one or more of the aforementioned α-olefins and aforementioned dienes. The catalysts according to the present invention are particularly suitable for the production of EP(D)M. Furthermore, the catalyst system according to the present invention is suitable for the polymerization of cycloolefins such as nobornene, cyclopentene, cyclohexene, cyclooctane, and the copolymerization of cycloolefins with ethylene or α-olefins.

The polymerization may be carried out in liquid phase, in the presence or absence of an inert solvent, or in the gaseous phase. Suitable solvents include aromatic hydrocarbons such as benzene and/or toluene, or aliphatic hydrocarbons such as propane, hexane, heptane, octane, isobutane, cyclohexane or mixtures of the various hydrocarbons.

It is possible to use the catalyst system according to the present invention supported on a carrier. The following may be mentioned, for example, as suitable supporting materials: inorganic or organic polymeric supports such as silica gel, zeolites, carbon black, activated carbon, aluminum oxide, polystyrene as well as polypropylene.

Supporting materials are preferably thermally and/or chemically pretreated in order specifically to adjust or maintain as low as possible the water content and/or the OH group concentration. A chemical pretreatment may, for example, comprise reacting the support with aluminum alkyl. Inorganic supports are usually heated before use to 100° C. to 1000° C. for 1 to 100 hours. The surface of such inorganic supports, in particular of silica (SiO₂), is between 10 and 100 m²/g, preferably between 100 and 800 m²/g. The particle diameter is between 0.1 and 500 micrometers (μ), preferably between 10 and 200μ.

The polymerization is generally carried out at pressures of 1 to 1,000 bar, preferably 1 to 100 bar. The polymerization may be carried out continuously or batchwise in conventional reactors.

For economic reasons, the pressures do not normally exceed a value of 30 bar, preferably 20 bar. According to the present invention, the polymerization is carried out in one or more reactors or reaction zones, for example, in a reactor cascade; in the case where several reactors are employed, different polymerization conditions may be established.

The polymerization is, as a rule, carried out at temperatures in the range from 0° C. to 200° C., preferably 20° C. to 150° C., more preferably 40° C. to 120° C., and most preferably 60° C. to 120° C.

The molar ratio of polymerizable monomer to the compound of the formula (I) is in the range from 1×10¹⁰:1 to 100:1, preferably from 1×10⁸:1 to 1000:1.

The molar ratio of the compound of the formula (II) to the compound of the formula (I) is in the range from 10,000:1 to 0.1:1, preferably 1000:1 to 1:1.

The polymers that can be obtained by the process according to the present invention are particularly suitable for producing all types of molded parts.

The invention is illustrated in more detail with the aid of the following examples.

### EXAMPLES

General information: the production and handling of organometallic compounds and the polymerizations were carried out under exclusion of air and moisture and under an argon atmosphere (Schlenk technique). All necessary solvents were dehydrated before use by boiling for several hours over a suitable drying agent followed by distillation under argon. Ammonium fluoride was purified by sublimation at 200° C. in vacuo (0.1 mbar).

The following compounds were obtained commercially from the specified companies:

Witco: triisobutylaluminum (TIBA),

rac-ethylenebis(tetrahydroindenyl)zirconium dichloride;

Aldrich: triethylamine trihydrofluoride;

Messer Griesheim GmbH: ethylene, propylene (purity 3.5);

rac-ethylenebis(tetrahydroindenyl)zirconium(2-vinylpyridine) was prepared

according to the literature instructions in Organometallics 1998,17, page 2097.

Polymer characterization: the IR spectroscopic determination of the polymer composition was carried out according to ASTM D 3900.

Abbreviations:

rac-(EBTHI )Zr rac-ethylenebis(tetrahydroindenyl)zirconium

TIBA triisobutylaluminum

RT room temperature

THI tetrahydroindenyl

Cp cyclopentadiene

### Example 1

Preparation of rac-(EBTHI)Zr(F){2-(2-pyridyl)ethyl} by reacting rac-(EBTHI)Zr(2-vinylpyridine) with ammonium fluoride (NH₄F) 260 mg (0.56 mmole) of rac-(EBTHI)Zr(2-vinylpyridine) and 21 mg (0.56 mmole) of NH₄F were stirred in 20 ml of toluene at 60° C. until the solution became decolored. The reaction solution was filtered, and the filtrate was concentrated to a high degree and covered with a layer of n-hexane. The desired compound crystallized at −30° C.

Yield: 188 mg (70%) of rac-(EBTHI)Zr(F){2-(2-pyridyl)ethyl}. Mp: 135° C., C₂₇H₃₂FNZr (480.78): calculated C 67.45, H 6.71, N 2.91; found C 65.72, H 6.81, N 2.81. ¹H NMR (C₆D₆), δ[ppm]=0.83 (C₂H₄-α), 1.23 (C₂H₄-α), 2.61 (ebthi-CH₂), 2.62 (ebthi-CH₂), 2.76 (ebthi-CH₂), 2.92 (ebthi-CH₂), 3.35 (C₂H₄-β), 3.61 (C₂H₄-β), 5.14 (“d”, CH ebthi), 5.76 (“d”, CH ebthi, J(H,F)=3.9 Hz), 5.87 (“d”, CH ebthi), 5.96 (“d”, CH ebthi, J(H,F)=4.8 Hz), 6.52 (“d”, CH4-H), 6.73 (“d”, CH2-H), 6.88 (“dt”, C3-H), 9.13 (“t”, C5-H, J(H,F)=6.4 Hz); ¹³C NMR (C₆D₆), δ[ppm]=22.8 ebthi-C₆), 22.9 (ebthi-C₆), 23.2 (ebthi-C₆), 23.3 (ebthi-C₆), 23.4 (ebthi-C₆), 23.8 (ebthi-C₆), 24.3 (ebthi-C₆), 24.7 (ebthi-C₆), 26.9 (ebthi-CH₂), 28.2 (ebthi-CH₂), 40.4 (C₂H₄-β), 41.8 (C₂H₄-α, J(C,F)=8.0 Hz), 104.1 (ebthi-Cp), 105.9 (ebthi-Cp, J(C,F)=4.4 Hz), 110.7 (ebthi-Cp), 112.0 (ebthi-Cp, J(C,F)=4.7 Hz), 116.7 (ebthi-Cp, J(C,F)=2.6 Hz), 120.4 (C4_{py}, J(C,F) =2.7 Hz), 121.7 (C2_{py}), 122.2 (ebthi-Cp, J(C,F)=2.3 Hz), 124.7 (ebthi-Cp, J(C,F)=2.4 Hz), 125.3 (ebthi-Cp), 128.3 (ebthi-Cp), 128.8 (ebthi-Cp), 137.5 (C3_{py}, J(C,F)=1.7 Hz), 149.7 (C5_{py}, J(C,F)=24.9 Hz), 170.1 (C1_{py}, J(C,F)=0.9 Hz); ¹⁹F NMR (C₆D₆), δ[ppm]=−52; MS (70 eV) m/z: 479

### Example 2

Preparation of rac-(EBTHI)Zr(F){2-(2-pyridyl)ethyl} by reacting rac-(EBTHl)Zr(2-vinylpyridine) with triethylamine trihydrofluoride (NEt₃.3HF) rac-(EBTHI)Zr(2-vinylpyridine) (359 mg, 0.78 mmole) was dissolved in 20 ml of toluene and NEt₃.3HF (42 μl, 0.26 mmole) was added at −40° C. The solution was then stirred until it became decolored. The reaction solution was filtered, and the filtrate was concentrated to a high degree and covered with a layer of n-hexane. The desired compound crystallized at −30° C.

Yield: 199 mg (53%) of rac-(EBTHI)Zr(F){2-(2-pyridyl)ethyl}.

### Example 3

Preparation of the catalyst. 15.8 mg (0.033 mmole) of rac-(EBTHI)Zr(F){2-(2-pyridyl)ethyl} from Example 1 were dissolved in 0.8 ml of TIBA and then diluted with 15.7 ml of toluene.

Copolymerization of ethylene and propylene. 500 ml of hexane and 1.0 ml of TIBA were placed in a 1.4 l capacity steel autoclave equipped with a mechanical stirrer, manometer, temperature sensor, a temperature regulating device, a catalyst hatch and devices for metering monomeric ethylene and propylene. The internal temperature was adjusted to 60° C. by means of a thermostat. 10 g of ethylene and 50 g of propylene were then metered in. The polymerization was started by adding 1.25 ml of the catalyst solution (2.5 μmole of zirconium).

Ethylene was continuously metered in so that the internal pressure at 60° C. remained constant at 9 bar. After 10 minutes of polymerization, the reaction was stopped, and the polymer was precipitated in methanol, separated, and dried for 20 hours at 60° C. in vacuo. 16.6 g of a copolymer were obtained having the following composition: 77.6 wt. % ethylene, 22.5 wt. % propylene (IR spectroscopic determination).

### Example 4

Copolymerization of ethylene and propylene. The polymerization of Example 3 was repeated except that, instead of hexane, 500 ml of toluene were added to the 1.4 l steel autoclave and the polymerization was carried out at 80° C. and 10 bar ethylene pressure. The polymerization duration was 20 minutes. 39.0 g of a copolymer were obtained having the following composition: 71.3 wt. % ethylene, 28.7 wt. % propylene (IR spectroscopic determination).

### Example 5

Preparation of the catalyst.

An orange-colored solution of 46 mg (0.1 mmole) of rac-(EBTHI)Zr(2-vinyl-pyridine) in 10 ml of toluene was added at RT to 3.7 mg (0.1 mmole) of NH₄F and stirred until the solution became decolored. 1 ml of the catalyst suspension contained 10 μmole of zirconium.

Polymerization of ethylene. 100 ml of toluene and 0.25 ml of TIBA were placed in a 250 ml glass reactor and heated to 60° C. Ethylene was then continuously passed into the solution at a pressure of 1.1 bar through a gas inlet tube. The polymerization was started by adding 1 ml of the catalyst suspension (10 μmole of zirconium). After 15 minutes of polymerization at a temperature of 60° C. and an ethylene pressure of 1.1 bar, the reaction was terminated by adding methanol and the polymer formed was filtered off, washed with acetone, and dried in a vacuum drying cabinet. 1.26 g of polyethylene were obtained.

### Example 6

### (Comparison example A)

Polymerization of ethylene.

The polymerization of Example 5 was repeated except that, instead of the catalyst suspension of Example 5, a solution of 10 μmole of rac-(EBTHI)Zr(2-vinylpyridine) in 1 ml of toluene without NH₄F was added as catalyst. 0.28 g of polyethylene was obtained.

### Example 7

Preparation of rac-(EBTHI)Zr(2-phenyl-2-vinylpyridine). rac-(EBTHI)ZrC1₂ (806 mg, 1.89 mmole) and 2-phenyl-2-vinylpyridine (342 mg, 1.89 mmole) and lithium (26 mg, 3.78 mmole) were suspended at −40° C. in 20 ml of THF. The reaction mixture was stirred for 24 hours at −40° C., the solution changing in color from deep red to reddish brown. The desired compound crystallized after filtering and keeping the filtrate at −30° C.

Yield: 578 mg (57%) of rac-(EBTHI)Zr(2-phenyl-2-vinylpyridine). Mp: 248° C., NMR (C₆D₆), δ[ppm] −0.32 (d,1 H), 0.98-1.06 (m,1 H), 1.22-1.58 (m), 1.90-2.01 (m), 2.12-2.53 (m), 2.64-2.77 (m), 2.90-2.99 (m), 4.81 (d, 1H), 4.95 (m, 2H), 5.00 (d, ³J=3.2 Hz, 1H, CH ebthi), 5.54 (dd, 2H), 5.56 (“dt”, 1H), 6.30 (m, 1H), 6.61 (d, 1H), 7.07 (t, 1H), 7.24 (d, 2H), 7.32 (t, 2H), 7.48 (d, 2H).

### Example 8

Preparation of the catalyst.

32 mg (0.06 mmole) of rac-(EBTHI)Zr(2-phenyl-2-vinylpyridine) from Example 7 were dissolved in 5 ml of THF. The red THF solution was added at RT to 2.2 mg (0.06 mmole) of NH₄F and stirred for 2 hours. The solution was then concentrated by evaporation, and the residue was dried in vacuo and stirred with 6 ml of toluene. 1 ml of the catalyst suspension contained 10 μmole of zirconium.

Polymerization of ethylene.

The polymerization of Example 5 was repeated except that, instead of the catalyst from Example 5, the catalyst suspension from Example 8 was added. 1.60 g of polyethylene were obtained.

### Example 9

(Comparison example B)

Polymerization of ethylene.

The polymerization of Example 8 was repeated except that, instead of the catalyst suspension from Example 8, a solution of 10 μmole of rac-(EBTHI)Zr(2-phenyl-2-vinylpyridine) in 1 ml of toluene without NH₄F was added as catalyst. 0.33 g of polyethylene was obtained.

### Example 10

Preparation of the catalyst solution.

An orange-colored solution of 70.2 mg (0.152 mmole) of rac-(EBTHI)Zr(2-vinylpyridine) in 10 ml of toluene was added to 5.6 mg (0.152 mmole) of NH₄F and stirred until the solution became decolored. 3.8 ml of TIBA were then added and the mixture was stirred for 1 hour, a clear solution being formed. The clear solution was diluted with 62.2 ml of toluene. 1 ml of the catalyst solution contained 2 μmole of zirconium.

Copolymerization of ethylene and propylene.

The polymerization of Example 3 was repeated except that, instead of hexane, 500 ml of toluene were added to the 1.4 l steel autoclave and the polymerization was carried out at 65° C. and 8 bar ethylene pressure. The polymerization was started with 1.25 ml of the catalyst solution (2.5 μmole of zirconium) from Example 10. The polymerization lasted for 20 minutes. 35.1 g of a copolymer were obtained having the following composition: 71.0 wt. % ethylene, 29.0 wt. % propylene (IR spectroscopic determination).

### Example 11

Preparation of (THI)₂Zr(F){2-(2-pyridyl)ethyl} by reacting (THI)₂Zr(2-vinylpyridine) with triethylamine trihydrofluoride (N Et₃.3H F). (THI)₂Zr(2-vinylpyridine) (296 mg, 0.68 mmole) was dissolved in 10 ml of toluene and NEt₃.3HF (37 μl, 0.226 mmole) was added. The reaction solution was stirred for 2 hours, during which it became brighter after about 30 minutes. Then the solution was filtered and the filtrate was concentrated to a high degree and covered with a layer of n-hexane. The desired compound crystallized at −30° C.

Yield: 130 mg (42%) of (THI)₂Zr(F){2-(2-pyridyl)ethyl}. Mp: 119° C., C₂₅H₃₀FNZr (454.74): calc. C 66.03, H 6.65, N 3.08; found: C 66.00, H 6.95, N 3.03. ¹H NMR (C₆D₆), δ[ppm]=1.11 (C₂H₄β), 1.28 1.38 1.46, 1.62 (THI-CH₂β), 2.07, 2.31, 2.50, 2.89 (THI-CH₂α), 3.44 (C₂H₄β), 5.39 (dd, J(H,H) 3.1 Hz, J(H,F) 2.2 Hz, THI-CH α), 5.52 (t, J(H,H) 3.1 Hz, THI-CH β), 5.59 (dd, J(H,H) 3.1 Hz, J(H,F) 2.2 Hz, THI-CH α), 6.53 (t, py 5-H), 6.71 (d, py 3-H), 6.87 (dt, py 4-H), 9.08 (“t”, J(H,H) 5.3 Hz, J(H,F) 6.7 Hz, py 6-H); ¹³C NMR (C₆D₆),δ[ppm]=23.4, 23.4, 24.3, 24.7 (THI-CH₂), 39.3 (C₂H₄β, J(C,F)=9.9 Hz), 40.6 (C₂H₄μ), 101.6, 105.8, 111.5 (THI-CH), 120.4 (py C5, J(C,F)=3.3 Hz), 122.2 (py C3), 122.9,126.8 (THI-C quaternary), 137.8 (py C4, J(C,F)=2.1 Hz), 149.5 (py C6),170.9 (py C2, J(C,F)=1 Hz); ¹⁹F NMR (C₆D₆), δ[ppm]=−47.2.

### Example 12

Preparation of (Cp)₂Zr(F){2-(2-pyridyl)ethyl} by reacting (Cp)₂Zr(2-vinylpyridine) with triethylamine trihydrofluoride (NEt₃.3HF). Cp₂Zr(2-vinylpyridine) (760 mg, 2.33 mmole) was dissolved in 20 ml toluene and NEt₃.3HF (126 μl, 0.776 mmole) was added. The reaction solution was stirred at 60° C. until it became decolored. It was then filtered and the filtrate was concentrated to a high degree and covered with a layer of n-hexane. The desired compound crystallised at −30° C.

Yield: 282 mg (35%) (Cp)₂Zr(F){2-(2-pyridyl)ethyl}. Mp: 98° C., C₁₇H₁₈FNZr (346.56): calc. C 58.92, H 5.24, N 4.04; found: C 56.92, H 4.92, N 3.54. ¹H NMR (C₆D₆), δ[ppm]=1.03 (C₂H₄α), 3.33 C₂H₄ β), 5.82 (Cp), 6.55 (dd, py 5-H), 6.71 (d, py 3-H), 6.90 (dt, py 4-H), 9.13 (dd, J(H,H) 5.4 Hz, J(H,F) 7.3 Hz, py 6-H); ¹³C NMR (C₆D₆), δ[ppm]=40.4 (C₂H₄α), 40.6 (C₂H₄β), 111.0 (Cp), 120.8 (py C5), 122.0 (py C3), 137.8 (py C4), 150.1 (py C6), 170.3 (py C2); ¹⁹F NMR (C₆D₆), δ[ppm]=−68.4.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composition comprising
a) a monofluorometal complex of the formula (I) 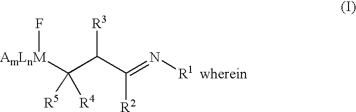
M is a metal from Groups III, IV, V or VI or from the group of lanthanoids or actinides of the Periodic System of the Elements according to IUPAC 1985,
R¹, R², R³, R⁴, R⁵ are identical or different and denote hydrogen, a C₁-C₂₀ alkyl group, a C₁-C₁₀ fluoroalkyl group, a C₆-C₁₀ fluoroaryl group, a C₁-C₁₀ alkoxy group, a C₆-C₂₀ aryl group, a C₆-C₁₀ aryloxy group, a C₂-C₁₀ alkenyl group, a C₇-C₄₀ arylalkyl group, a C₇-C₄₀ alkylaryl group, a C₈-C₄₀ arylalkenyl group, a C₂-C₁₀ alkinyl group, a silyl group optionally substituted by C₁-C₁₀ hydrocarbon radicals, or
R¹, R², R³, R⁴, R⁵ in each case together with the atoms bonding them form one or more aliphatic or aromatic ring systems that may contain one or more heteroatoms (O, N, S) and that have 5 to 10 carbon atoms
A denotes an optionally singly or multiply bridged anionic ligand,
F denotes a fluorine atom,
L is a non-ionic ligand,
m is 1, 2, 3,
n is 0, 1, 2, 3, 4, and
b) is a compound of the formula (II)
M′Y₃ (II)
wherein
M′ denotes boron or aluminum and
Y is identical or different and denotes hydrogen, a linear or branched C₁-C₂₀ alkyl group optionally substituted by silyl groups, a linear or branched C₁-C₁₀ fluoroalkyl group, a C₆-C₁₀ fluoroaryl group, a C₁-C₁₀alkoxy group, a C₆-C₂₀ aryl group, a C₆-C₂₀ aryloxy group, a C₇-C₄₀ arylalkyl group, or a C₇-C₄₀ alkylaryl group.

2. A composition according to claim 1, wherein n is 1, 2 or 3.

3. A composition according to claim 1, wherein said monofluorometal complex is of the formula (Ia) 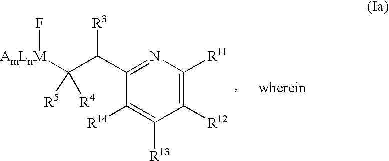
R¹¹, R¹², R¹³ and R¹⁴ are identical or different and denote hydrogen or a C₁-C₁₀ alkyl group.

4. A composition according to claim 1, wherein M denotes titanium, zirconium or hafnium.

5. A composition according to claim 1, wherein A denotes an optionally substituted cyclopentadienyl ring.

6. A composition according to claim 1, wherein M′Y₃ denotes triethylaluminum, diisobutylaluminum hydride, triisobutylaluminum, tri-(2-phenylpropyl)aluminum or tri-(2,4,4-trimethylpentyl)aluminum.

7. A catalyst system containing a composition comprising
a) a monofluorometal complex of the formula (I) 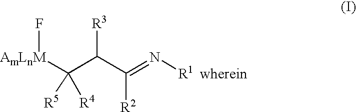
M is a metal from Groups III, IV, V or VI or from the group of lanthanoids or actinides of the Periodic System of the Elements according to IUPAC 1985,
R¹, R², R³, R⁴, R⁵ are identical or different and denote hydrogen, a C₁-C₂₀ alkyl group, a C₁-C₁₀ fluoroalkyl group, a C₆-C₁₀ fluoroaryl group, a C₁-C₁₀ alkoxy group, a C₆-C₂₀ aryl group, a C₆-C₁₀ aryloxy group, a C₂-C₁₀ alkenyl group, a C₇-C₄₀ arylalkyl group, a C₇-C₄₀ alkylaryl group, a C₈-C₄₀ arylalkenyl group, a C₂-C₁₀ alkinyl group, a silyl group optionally substituted by C₁-C₁₀ hydrocarbon radicals, or
R¹, R², R³, R⁴, R⁵ in each case together with the atoms bonding them form one or more aliphatic or aromatic ring systems that may contain one or more heteroatoms (O, N, S) and that have 5 to 10 carbon atoms
A denotes an optionally singly or multiply bridged anionic ligand,
F denotes a fluorine atom,
L is a non-ionic ligand,
m is 1, 2, 3,
n is 0, 1, 2, 3, 4, and
b) is a compound of the formula (II)
M′Y₃ (II)
wherein
M′ denotes boron or aluminum and
Y is identical or different and denotes hydrogen, a linear or branched C₁-C₂₀ alkyl group optionally substituted by silyl groups, a linear or branched C₁-C₁₀ fluoroalkyl group, a C₆-C₁₀ fluoroaryl group, a C₁-C₁₀ alkoxy group, a C₆-C₂₀ aryl group, a C₆-C₂₀ aryloxy group, a C₇-C₄₀ arylalkyl group, or a C₇-C₄₀ alkylaryl group.

8. A catalyst system according to claim 7, wherein said catalyst system is used in supported form.

9. A process for the polymerization of α-olefins or mixtures of α-olefins and optionally dienes, comprising the step of polymerization being carried out in the presence of a catalyst system containing a composition comprising
a) a monofluorometal complex of the formula (I) 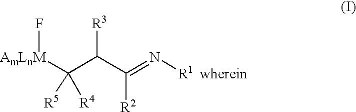
M is a metal from Groups III, IV, V or VI or from the group of lanthanoids or actinides of the Periodic System of the Elements according to IUPAC 1985,
R¹, R², R³, R⁴, R⁵ are identical or different and denote hydrogen, a C₁-C₂₀ alkyl group, a C₁-C₁₀ fluoroalkyl group, a C₆-C₁₀ fluoroaryl group, a C₁-C₁₀ alkoxy group, a C₆-C₂₀ aryl group, a C₆-C₁₀ aryloxy group, a C₂-C₁₀ alkenyl group, a C₇-C₄₀ arylalkyl group, a C₇-C₄₀ alkylaryl group, a C₈-C₄₀ arylalkenyl group, a C₂-C₁₀ alkinyl group, a silyl group optionally substituted by C₁-C₁₀ hydrocarbon radicals, or
R¹, R², R³, R⁴, R⁵ in each case together with the atoms bonding them form one or more aliphatic or aromatic ring systems that may contain one or more heteroatoms (O, N, S) and that have 5 to 10 carbon atoms
A denotes an optionally singly or multiply bridged anionic ligand,
F denotes a fluorine atom,
L is a non-ionic ligand,
m is 1, 2, 3,
n is 0, 1, 2, 3, 4, and
b) is a compound of the formula (II)
M′Y₃ (II)
wherein
M′ denotes boron or aluminum and
Y is identical or different and denotes hydrogen, a linear or branched C₁-C₂₀ alkyl group optionally substituted by silyl groups, a linear or branched C₁-C₁₀ fluoroalkyl group, a C₆-C₁₀ fluoroaryl group, a C₁-C₁₀ alkoxy group, a C₆-C₂₀ aryl group, a C₆-C₂₀ aryloxy group, a C₇-C₄₀ arylalkyl group, or a C₇-C₄₀ alkylaryl group.

10. A process according to claim 9, wherein polymerization is carried out in the presence of an aromatic hydrocarbon.

11. A process according to claim 9, wherein the catalyst system is used in supported form.

12. A process according to claims 9, wherein polymerization is carried out at a temperature in the range from 60° C. to 120° C.

13. A process according to claim 9 for the production of EP(D)m.

14. A process for the production of monofluorometal complexes of the formula (I) 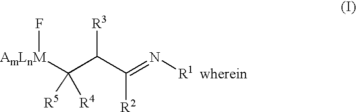
M is a transition metal from Groups III, IV, V or VI or from the group of lanthanoids or actinides of the Periodic System of the Elements according to IUPAC 1985,
R¹, R², R³, R⁴, R⁵ are identical or different and denote hydrogen, a C₁-C₂₀ alkyl group, a C₁-C₁₀ fluoroalkyl group, a C₆-C₁₀ fluoroaryl group, a C₁-C₁₀ alkoxy group, a C₆-C₂₀ aryl group, a C₆-C₁₀ aryloxy group, a C₂-C₁₀ alkenyl group, a C₇-C₄₀ arylalkyl group, a C₇-C₄₀ alkylaryl group, a C₈-C₄₀ arylalkenyl group, a C₂-C₁₀ alkinyl group, or a silyl group optionally substituted by C₁-C₁₀ hydrocarbon radicals, or
R¹, R², R³, R⁴, R⁵ in each case together with the atoms bonding them form one or more aliphatic or aromatic ring systems that may contain one or more heteroatoms (O, N, S) and that have 5 to 10 carbon atoms
A denotes an optionally singly or multiply bridged anionic ligand,
F denotes a fluorine atom,
L is a non-ionic ligand,
m is 1,2,3,
n is 0, 1, 2, 3, 4,
comprising the step of reacting a monoazadiene complex of the formula (III) 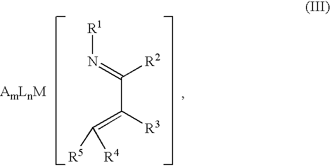
with anhydrous hydrogen fluoride or with an addition complex containing hydrogen fluoride in bound form.

15. A process according to claim 14, wherein n is 1, 2 or 3.
